(19) United States
(12) Patent Application Publication
(10) Pub. No.: US 2021/0019601 A1
(43) Pub. Date: Jan. 21, 2021

(54) System and Method for Face Detection and Landmark Localization

(71) Applicant: CARNEGIE MELLON UNIVERSITY, Pittsburgh, PA (US)

(72) Inventors: Ian Richard Lane, Sunnyvale, CA (US); Bo Yu, Beijing (CN)

(73) Assignee: CARNEGIE MELLON UNIVERSITY, Pittsburgh, PA (US)

(21) Appl. No.: 17/063,601

(22) Filed: Oct. 5, 2020

Related U.S. Application Data
(63) Continuation of application No. 15/435,273, filed on Feb. 16, 2017.
(60) Provisional application No. 62/389,058, filed on Feb. 16, 2016.
(60) Provisional application No. 62/389,048, filed on Feb. 16, 2016.

(51) Int. Cl. G06N 3/04; G06N 3/08; G06K 9/62; G06K 9/00

(52) U.S. Cl. CPC G06N 3/0454; G06N 3/084; G06K 9/00288; G06K 9/00248; G06K 9/6273

(57) ABSTRACT

Disclosed herein is a deep learning model that can be used for performing speech or image processing tasks. The model uses multi-task training, where the model is trained for at least two inter-related tasks. For face detection, the first task is face detection (i.e. face or non-face) and the second task is facial feature identification (i.e. mouth, eyes, nose). The multi-task model improves the accuracy of the task over single-task models.

### CROSS-REFERENCE TO RELATED APPLICATIONS

This application is a continuation of application Ser. No. 15/435,273, filed on Feb. 16, 2017, which claims the benefit under 35 U.S.C. § 119 of Provisional Application Ser. No. 62/389,058, filed on Feb. 16, 2016, and Provisional Application Ser. No. 62/389,048, filed on Feb. 16, 2016, each of which is incorporated herein by reference.

### STATEMENT REGARDING FEDERALLY SPONSORED RESEARCH

Not applicable.

### BACKGROUND OF THE INVENTION

The invention relates generally to deep learning models for use in speech and image processing tasks. More specifically, the invention relates to a method of deep learning models using multi-task training.

Deep learning models provide exceptional performance across many speech and image processing tasks, often significantly outperforming many other methods. However, most deep learning models rely on single-task learning when used for image processing, where the task represents the purpose for learning process. Single-task learning focuses on the information of main purpose only, regardless of other related information.

As a result, it can be more difficult to classify complex objects with various shapes, outlines, orientations, and sizes in the real world, such as face detection and object recognition. 3D information (color and depth) is a way to simplify complex object classification by adding distance to make the object of interest stereo. Also, depth data guides in detecting face or recognizing objects, especially in cases where images are rotated, overlapped, exposed to different illumination, or even distorted by noise. However, the combination of depth information and 2D texture images has not been fully explored for improving recognition rates.

Mostly, methods in face recognition using 3D information are surface based. One method in use represents each point in a face with its corresponding facial level curve by calculating the distance between curves in the same level, which are classified by HMM (Hidden Markov Models). Another method uses curvature analysis in face detection. Further, methods used in 3D object recognition are mainly based on handcrafted features, which require a strong analysis of object of interest. Moreover, the features extracted are arguable, as they are limited to different knowledge background.

Such limitations can be reduced by deep learning algorithms. Deep learning methods enhance performance in face recognition, facial key point detection, and object detection by learning hierarchical features using raw data only. However, deep learning methods in face recognition based on both depth and 2D images have not been used.

### BRIEF SUMMARY

According to embodiments of the present invention is a method of multi-task learning, involving a single-task and a secondary-task. The single-task focuses on training using information of the main application. The secondary-task, on the other hand, learns features from relative information, which can be anything related to the main purpose. For example, if face detection is to be performed using a multi-task model, the relative information can be landmarks on the face. The combination of features learned from the main and relative information can help improve accuracy in achieving main application. The multi-task model has been applied to neural network for classification. However, the network is shallow, and features extracted are not hierarchical.

Embodiments of the present invention focus on the performance of mutli-task models in image understanding. The multi-task deep learning model is based on Convolutional Neural Network(CNN) and Denoising Autoencoder (DA), which can be applied to face detection and object recognition using 3D information (color and depth).

### BRIEF DESCRIPTION OF THE SEVERAL VIEWS OF THE DRAWINGS

FIG. 1 is a depiction of the model according to one embodiment.

FIG. 2 is a graph comparing detection rates for various models.

FIG. 3 shows a model according to an alternative embodiment.

### DETAILED DESCRIPTION

According to embodiments of the present invention is a method that improves the performance of deep learning models by introducing multi-task training, in which a combined deep learning model is trained for two inter-related tasks. By introducing a secondary task (such as shape identification in the object classification task), the method is able to significantly improve the performance of the main task for which the model is trained. The method can be utilized in tasks such as image segmentation and object classification. On the image segmentation task, the multi-task model nearly doubled the accuracy of segmentation at the pixel-level (from 18.7% to 35.6%) compared to the single task model, and improved the performance of face-detection by 10.2% (from 70.1% to 80.3%). For the object classification task, the model provided a 2.1% improvement in classification accuracy (from 91.6% to 93.7%) compared to a single-task model. These results demonstrate the effectiveness of multi-task training of deep learning models for image understanding tasks.

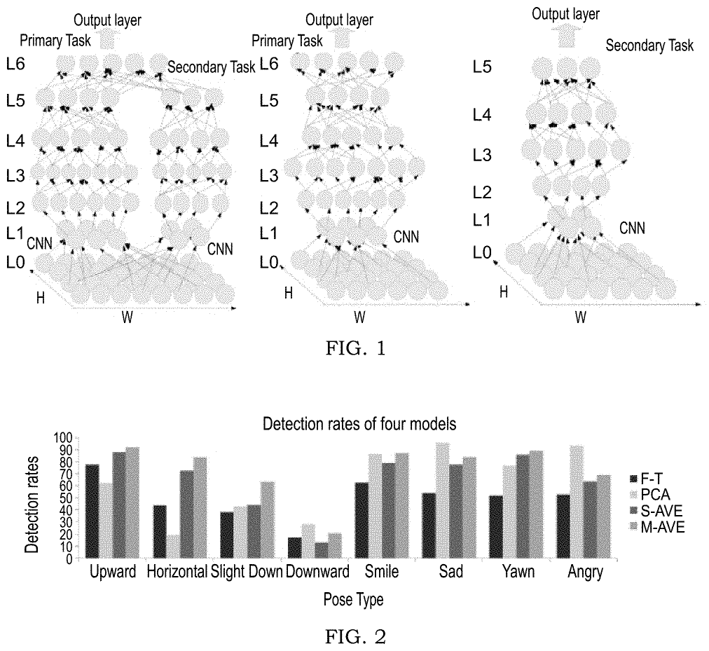

In one embodiment, the model is composed of two sub tasks. A single-task focuses on the main purpose, while the secondary-task works for something related. For example, for face detection, the single-task is to classify each pixel as face or non-face, and the secondary-task is to determine each pixel to be one of the landmarks on the face (eyes, nose, mouth, face skin) or non-face. In the case of object recognition, classifying each object into one of the categories is the single-task. Classifying each object into one of four pre-defined shape categories can be selected as secondary-task to enhance the ability to distinguish different objects in single-task. Secondary-task supplements single-task by forcing multi-task to learn internal representation between main purpose and related one. To get most out of multi-task learning, each task is trained separately. For both cases, the secondary-task was first trained with its corresponding label to get supplementary features. The single-task was further trained on top of the parameters trained in the secondary one. The classification labels of output layer in face detection are face and non-face, while in object recognition, labels are determined by the categories in the dataset. FIG. 1 shows an example of the model.

Generally, the whole model is composed of a secondary task (right image of FIG. 1) and a single task (center image of FIG. 1). The secondary task consists of 6 layers (from L0 to L5). The single-task includes 7 layers (from L0 to L6). In addition, the secondary task and single task share the same input layer L0. The combination of L5 in a single task and secondary task forms the input of hidden layer L6. Finally, the output layer of the whole model is trained in single task. The first layer is the original image with width of W and height of H. L1 is the convoluted and pooled layer in both tasks. L2 is one dimensional, reshaped from L1. L3 is a hidden layer in both secondary and single tasks. L4 is the hidden layer of denoising auto-encoder to enhance the ability of the model in resisting noise and to decrease feature dimension. L5 is another hidden layer. Both sub-structures in layers L4 and L5 are the same.

Training and optimization

Each subtask is trained separately. The secondary-task is trained first. Optimized parameters trained for each layer are recorded. The single-task is then trained with the same training set. During single-task training, when coming to L5 in each epoch, L5 in secondary-task is calculated using the optimized parameters trained previously. Values in L5 of single-task and secondary-task are then combined and used to generate L6. When doing back-propagation, parameters in the secondary-task remain the same, only those in single-task are updated. To avoid overfitting, weight decay and early stopping are used. Early stopping outweighs the performance of regularization algorithms in many situations. In one embodiment, the stopping criteria is calculated using validation error, which is obtained from validation set. Validation set was randomly selected from training data, taking up 20%. By early stopping criteria, the training time is shortened. However, there is a risk that early stopping may not work well without a good definition of the criteria. Weight decay is used in a cost function, using a scale parameter of 0.003.

To reduce the impact of possible unbalanced training data, the method adopts probabilistic sampling in cost function. Different learning rates were used. In single-task, the learning rate was 0.001, while for secondary-task, 0.01 worked well.

The model was evaluated in two application areas, face detection and object recognition. These are two of the most active areas in image processing. In face detection, the largest challenge is low detection rates in various poses and illumination conditions. For object recognition, different viewing angles and shapes for one category objects are the main obstable. For a face dataset and an object dataset, all of the 2D images were first transformed to YUV, because RGB is not perceptually uniform. Next, both YUV and depth images were normalized by divisive constrast normalization. Divisive contrast normalization was adopted because it could reveal the local contrast of each pixel, rather than normalize all the pixel intensities of an image to a specific scale only. It is more suitable for the model since local information plays a key role in describing different subjects.

Experiment for face detection

Depth data in the dataset was synchronized to 2D images. Finally, all the depth and YUV matrices were downsampled into 320×240 pixels by linear interpolation. Owing to the fact that the model for face detection is pixel-based image segmentation, a sub-region in the size of 51×51 centered at each pixel in the image was generated and used as a sample to do face detection. Each sub-region was assigned by the label of its center pixel. Three images from different people were selected for each pose to generate training data. For each selected image, 51×51 sub-regions were generated for training, centered by all the pixels. Therefore, the experiment had 3,234,675 trainig samples. Of all the training data, 20% of which were randomly selected as validation set to calculate early stopping criteria. Test data was composed of all the other images in the dataset.

Experimental Setup: To analyze performance of the model on the dataset in detail, six experiments were conducted in total: (1)Single-task model using 2D data (S-C); (2)Single-task model using depth data (S-D); (3)Single-task model using 3D data(S-CD); (4) Multi-task model using 2D data (M-C); (5)Multi-task model using depth data (M-D); and (6)Multi-task model using 3D data (M-CD) (see Table I). In the model structure (see FIG. 1), L0 is 51×51×4 pixels (4 represents 4 channels, Y,U,V and Depth). The filter size in single-task is 36×36 pixels and 46×46 in secondary. L2 is in size of 1080 and 7680 respectively in single and secondary tasks. L3 is 1000 in both tasks. L4 decreases the feature size from 1000 to 500. L5 also reduces the feature size from 500 to 300.

TABLE I
EXPERIMENTAL CONDITIONS

| ID | Abbreviation | Model-type | Features |
|---|---|---|---|
| 1 | S-C | Single-task | color |
| 2 | S-D | Single-task | depth |
| 3 | S-CD | Single-task | color + depth |
| 4 | M-C | Multi-task | color |
| 5 | M-D | Multi-task | depth |
| 6 | M-CD | Multi-task | color + depth |

Results and analysis: Faces detected by models other than multi-task using 3D data are usually the same. Their bounding boxes take similar shape and position. Nonetheless, faces detected by mutli-task using 3D data are more practical, with fewer pixels misclassified as faces. To evaluate the performance of the model more objectively and statistically, detection rates of each pose among all the data were calculated in the six experiments from (1)(S-C) to (6)(M-CD). The performance evaluation was divided into two parts. One is multi-task model vs. single-task and two other published results (see Table II). The other is using 3D vs. 2D or depth data (see Table III).

TABLE II
ACCURACY(%) OF DETECTION RATES ON VAP DATASET BY
MULTI-TASK MODEL, SINGLE-TASK MODEL, FACE TRIANGLES
DETECTION(F-T) [9] AND PCA(FROM [10])

| Data | F-T | PCA | S-AVE | M-AVE |
|---|---|---|---|---|
| Overall accuracy | 51.7 | 58.3 | 70.2 | 80.3 |

TABLE III
ACCURACY OF DETECTION RATES ON VAP
DATASET BY SINGLE-TASK(S) AND
MULTI-TASK(M) USING COLOR (C), DEPTH (D),
COLOR-DEPTH (CD) DATA SEPERATELY(%)

| Method | C | D | CD |
|---|---|---|---|
| Single-task | 66.2 | 66.3 | 70.2 |
| Multi-task | 75.4 | 75.2 | 80.3 |

Multi-task model vs. Other model

From Table II it is shown the model of the present invention substantially improved the accuracy of face detection on the dataset by more than 20%, compared with other detection methods. Moreover, the accuracy of the multi-task model outweighs that of a single-task model by almost 10%. This indicates that the secondary-task, together with a shared representation, helps learn features more accurately. Nevertheless, all the methods show a poor performance when people look downward (see FIG. 2). There is a possibility that a shadow overlaps the face when posing downward, which hinders detecting the face. Moreover, PCA fluctuates with different pose markedly, and F-T performs smoothly but obtains the lowest or the second lowest detection rates. Statistically, multi-task model significantly improved the detection accuracy compared with baselines F-T (99.8%>95%), PCA (99.7%>95%).

3D vs. 2D or depth data 3D data work better than color or depth data only. Still, models using 3D data perform substantially better than those using 2D data or depth data (see Table III). Multi-task model achieves better segmentation accuracy than single-task model (see Table IV), which agrees with the observations previously discussed. Further experiments show that M-CD not only significantly outperforms M-C (99.998%>95%), M-D (99.998%>95%), S-CD (99.998%>95%), S-C (99.995%>95%), or S-D (99.998%>95%) in terms of segmentation accuracy, but also improves significantly in detection rates (M-C: 99.999%>95%, M-D: 99.999%>95%, S-CD: 99.998%>95%, S-C: 99.999%>95% and S-D: 99.999%>95%). Consequently, multi-task model using 3D data can be used to detect face more practically and accurately.

TABLE IV
ACCURACY OF SEGMENTATION USING
S-C, S-D, S-CD, M-C, M-D, M-CD AT PIXEL LEVEL(%)

| Method | C | D | CD |
|---|---|---|---|
| Single-task | 17.9 | 17.8 | 18.7 |
| Multi-task | 19.1 | 19.5 | 35.6 |

Experiment for object recognition

Unlike segmentation, object recognition needs a whole image as input. Therefore, all the data in the dataset was resized to 51×51 pixels. The secondary-task uses shape character of objects in building multi-task model. Among the 250,000 color-depth images in the dataset, 41,877 color-depth images were used as testing data. Similar to the experiment before, six combinations of single-task, mutli-task using depth, color and color-depth data were used to perform object recognition. The corresponding recognition rates and state-of-art results are shown in Table V.

TABLE V
ACCURACY(%) OF OBJECT RECOGNITION ON
RGB-D OBJECT DATASET.

| Method | C | D | CD |
|---|---|---|---|
| Lai et al. [15] | 74.5 | 64.7 | 83.8 |
| Lai et al. [25] | 78.6 | 70.2 | 85.4 |
| Bo et al. [24] | 80.7 | 80.3 | 86.5 |
| Bo et al. [23] | 82.4 | 81.2 | 87.5 |
| Single-task model | 90.8 | 85.3 | 91.6 |
| Multi-task model | 92.3 | 92.4 | 93.7 |

CD IS SHORT FOR COLOR-DEPTH DATA.

It is worth noting that multi-task model using 3D data performs the best compared with state-of-art methods on this dataset. In terms of using 2D or depth data, multi-task achieves 10% higher accuracy than other methods. In addition, the performance of multi-task using 3D data outweighs that of other methods (see Table V). On top of that, statistical analysis indicates that multi-task model using 3D data improves the performance significantly compared with recently proposed baseline performances as well (see Table VI).

TABLE VI
PERFORMANCE(%) OF OBJECT RECOGNITION
ON RGB-D OBJECT DATASET.

| Method | Confidence interval |
|---|---|
| Linear SVMs [15] | [79.1-84.7] |
| Nonlinear SVMs [15] | [80.3-87.3] |
| Random Forest [15] | [75.6-83.6] |
| Combination of all HKDES [24] | [81.9-86.3] |
| Muiti-task using color-depth | [89.9-94.3] |

Designing hand-crafted features is difficult and time demanding. Single task model learns monotonous features, which conveys relative information and cannot fully represent features of different objects. As such, the results indicate that deep learning based multi-task model can be used to improve recognition and detection rates in various image processing applications markedly.

In an alternative embodiment, a neural network-based approach for object detection in images is used. For example, for localization in face detection, many methods use manual feature detection and description. Topological parameters have to be statistically analyzed to fit different facial structures. This requires strong domain knowledge background about faces, which must be passive to various poses and illumination conditions.

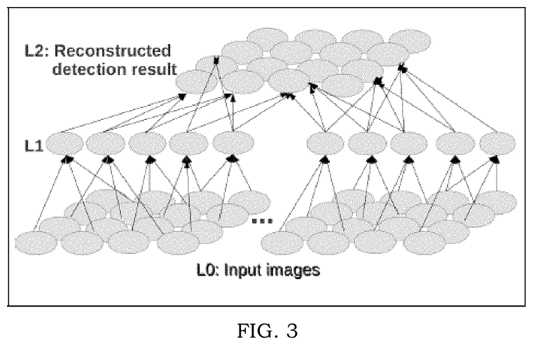

As such, an alternative embodiment of the present invention uses a reconstruction network to learn representation of faces and facial landmarks automatically, generating detected regions of interest directly. The reconstruction network is based on the idea of de-noising autoencoder, which is one of the most widely used unsupervised training models in deep neural networks. Its core idea is to learn the representative features by reconstructing input data. The model of the present invention focuses on reconstructing part of the image (object of interest), using a combination of learned features from all the source images. A description of this model is shown in FIG. 3.

The structure of the reconstruction network is simple. There are three layers. L0 is the input layer. L1 is composed of several different hidden layers, extracted from the unsupervised denoising autoencoder. L2 synthesizes hidden features in layer L1, reconstructing an output image with the detected object region. Layer L2 takes the same size with input image.

The object function of the model is described in Equation 1.

$$L = \frac{1}{2 n} \sum ( {y}_{target} log {y}_{reconstructed} + ( 1 - {y}_{target} ) log ( 1 - {y}_{reconstructed} ) ) \qquad ( 1 )$$

It takes similar form with de-noising autoencoder. Rather than minimizing difference between reconstructed image and the original image, the object function minimizes the error between reconstructed image and the target image. The parameter settings, such as learning rate and layer size.

The reconstruction network is region-based detection, the number of pixels of interest is not fixed. Further, the reconstruction network generates regions of interest directly, rather than a fixed number of key points. To deal with such problem, four landmark key points are calculated from the detected contours of the method. Each key point was a center of each facial landmark contour. Thus, the reconstruction network focuses on generating regions of interest directly by forcing the network to learn topological relationships between object of interest and its background. The reconstruction network has 4 main advantages: (1) it works easily and computes effectively; (2) it does not require strong domain knowledge about statistics; (3) regions of interest can be generated directly, even under various head orientation and illumination conditions; and (4) generated regions of interest supply more applications and detection robustness than limited number of key points.

While the disclosure has been described in detail and with reference to specific embodiments thereof, it will be apparent to one skilled in the art that various changes and modification can be made therein without departing from the spirit and scope of the embodiments. Thus, it is intended that the present disclosure cover the modifications and variations of this disclosure provided they come within the scope of the appended claims and their equivalents.

What is claimed is:

1. A method for performing an image processing task for face detection comprising:
training a deep learning model, wherein the deep learning model identifies features by reconstructing input data; and
processing an image using the deep learning model.

2. The method of claim 1, wherein reconstructing input data comprises:
using a combination of learned features from the input data, wherein the input data comprises a plurality of images.

3. The method of claim 1, wherein the model generates regions of interest directly by identifying a topological relationship between an object of interest and a background of the object of interest.
